(19) United States
(12) Patent Application Publication
(10) Pub. No.: US 2007/0298261 A1
(43) Pub. Date: Dec. 27, 2007

(54) Aqueous Paper Coating Slip Containing Pigment-Polymer Hybrids

(76) Inventors: Jurgen Schmidt-Thummes, Neuhofen (DE); Christoph Hamers, Ludwigshafen (DE)

Correspondence Address: OBLON, SPIVAK, MCCLELLAND MAIER & NEUSTADT, P.C., 1940 DUKE STREET, ALEXANDRIA, VA, 22314, US

(21) Appl. No.: 11/719,070

(22) PCT Filed: Nov. 5, 2005
(86) PCT No.: PCT/EP05/11849

§ 371 Date: May 10, 2007

(30) Foreign Application Priority Data
Nov. 12, 2004 (DE) 10 2004 054 912.5

(51) Int. Cl. B32B 9/06; C09D 201/00

(52) U.S. Cl. 428/411.1; 106/285; 106/287.35

(57) ABSTRACT

An aqueous paper coating slip comprising organic polymers as binders and inorganic pigments, wherein the binders are present at least partly in the form of a pigment-polymer hybrid in which the binder is chemically or physically bound to the inorganic pigments.

The invention relates to aqueous paper coating slips comprising
organic polymers as binders and inorganic pigments, wherein the binders are present at least partly in the form of a pigment-polymer hybrid in which the binder is chemically or physically bound to the inorganic pigments.

Paper coating slips substantially comprise pigment and binder. The binder is intended to fix the pigment on the paper and to ensure the cohesion in the coating obtained.

During the printing process, for example in an offset printing press, high tensile forces act on the coated paper owing to the high viscosity of the printing ink. The resistance with which the coated paper opposes these forces is referred to as pick resistance. Depending on the humidity state, a distinction is made between dry pick resistance and wet pick resistance.

Composite particles of inorganic pigments and organic polymers are disclosed, for example, in WO 93/12183; the composite particles are used in paints.

Anhydrous paper coating slips which comprise composite particles of organic pigments and organic polymers are described in WO 01/00712 and WO 01/00713.

Pigment-polymer hybrids and processes for the preparation hereof are disclosed in patent application FR 04 07 806 from Omya (date of application Jul. 13, 2004).

In the case of paper coating slips known to date, the binding power of the binder and hence the pick resistance are still insufficient.

It was therefore an object of the present invention to provide paper coating slips having improved pick resistance.

Accordingly, the paper coating slip described at the outset was found.

A substantial component of the paper coating slips is a binder. Suitable binders are natural and synthetic polymers. For example, starch is a suitable natural polymer.

Suitable synthetic polymers are in particular polymers which are obtainable by free radical polymerization of ethylenically unsaturated compounds (monomers).

The binder is preferably a polymer which comprises at least 40% by weight, preferably at least 60% by weight, particularly preferably at least 80% by weight, of so-called main monomers.

The main monomers are selected from C₁-C₂₀-alkyl(meth)acrylates, vinyl esters of carboxylic acids comprising up to 20 carbon atoms, vinyl aromatics having up to 20 carbon atoms, ethylenically unsaturated nitriles, vinyl halides, vinyl ethers of alcohols comprising 1 to 10 carbon atoms, aliphatic hydrocarbons having 2 to 8 carbon atoms and one or two double bonds or mixtures of these monomers.

For example, alkyl(meth)acrylates having a C₁-C₁₀-alkyl radical, such as methyl methacrylate, methyl acrylate, n-butyl acrylate, ethyl acrylate and 2-ethylhexyl acrylate, may be mentioned.

Mixtures of the alkyl(meth)acrylates are also particularly suitable.

Vinyl esters of carboxylic acids having 1 to 20 carbon atoms are, for example, vinyl laurate, vinyl stearate, vinyl propionate, vinyl versatate and vinyl acetate.

Suitable vinyl aromatic compounds are vinyltoluene, α- and p-methylstyrene, α-butylstyrene, 4-n-butylstyrene, 4-n-decylstyrene and preferably styrene. Examples of nitriles are acrylonitrile and methacrylonitrile.

The vinyl halides are ethylenically unsaturated compounds substituted by chlorine, fluorine or bromine, preferably vinyl chloride and vinylidene chloride.

For example, vinyl methyl ether or vinyl isobutyl ether may be mentioned as vinyl ethers. Vinyl ethers of alcohols comprising 1 to 4 carbon atoms are preferred.

Ethylene, propylene, butadiene, isoprene and chloroprene may be mentioned as hydrocarbons having 2 to 8 carbon atoms and one or two olefinic double bonds.

Preferred main monomers are C₁-C₁₀-alkyl(meth)acrylates and mixtures of alkyl (meth)acrylates with vinyl aromatics, in particular styrene, (polymers comprising these main monomers are referred to altogether as polyacrylates for short) or, alternatively, hydrocarbons having 2 double bonds, in particular butadiene, or mixtures of such hydrocarbons with vinyl aromatics, in particular styrene, (polymers comprising these main monomers are referred to altogether as polybutadienes for short).

In the case of mixtures of aliphatic hydrocarbons (in particular butadiene) with vinyl aromatics (in particular styrene), the ratio may be, for example, from 10:90 to 90:10, in particular from 20:80 to 80:20.

In addition to the main monomers, the polymer may comprise monomers having at least one acid group (acid monomer for short), for example monomers having carboxyl, sulfo or phosphonic acid groups. Carboxyl groups are preferred. For example, acrylic acid, methacrylic acid, itaconic acid, maleic acid or fumaric acid may be mentioned.

Further monomers are moreover, for example, monomers comprising hydroxyl groups, in particular C₁-C₁₀-hydroxyalkyl(meth)acrylates, and (meth)acrylamide.

In the case of the polybutadienes, particularly preferred polymers are accordingly composed of

from 10 to 90% by weight, preferably from 20 to 70% by weight, of aliphatic hydrocarbons having two double bonds, in particular butadiene from 10 to 90% by weight, preferably from 30 to 80% by weight, of vinyl aromatic compounds, in particular styrene from 0 to 20% by weight, preferably from 0 to 10% by weight, of acid monomer from 0 to 20% by weight, preferably from 0 to 10% by weight, of further monomers

or, alternatively, in the case of the polyacrylates, of

from 10 to 95% by weight, preferably from 30 to 95% by weight, of C₁- to C₁₁₀-alkyl (meth)acrylates

from 0 to 60% by weight, preferably from 0 to 50% by weight, of vinyl aromatic compounds, in particular styrene and

from 0 to 20% by weight, preferably from 0 to 10% by weight, of acid monomer

from 0 to 20% by weight, preferably from 0 to 10% by weight, of further monomers.

Both the polybutadienes and the polyacrylates preferably comprise acid monomers as comonomers, preferably in an amount of from 1 to 5% by weight. The maximum amount of the above aliphatic hydrocarbons in the polybutadienes or of the alkyl (meth)acrylates in the polyacrylates decreases according to the minimum amount of the acid monomers.

In a preferred embodiment, the polymers are prepared by emulsion polymerization, and the polymer obtained is therefore an emulsion polymer.

However, the preparation can also be effected, for example, by solution polymerization and subsequent dispersing in water.

In the emulsion polymerization, ionic and/or nonionic emulsifiers and/or protective colloids or stabilizers are used as surface-active compounds.

The surface-active substance is usually used in amounts of from 0.1 to 10% by weight, based on the monomers to be polymerized.

Water-soluble initiators for the emulsion polymerization are, for example, ammonium and alkali metal salts of peroxodisulfuric acid, e.g. sodium peroxodisulfate, hydrogen peroxide or organic peroxides, e.g. tert-butyl hydroperoxide.

So-called reduction-oxidation (redox) initiator systems are also suitable.

The amount of the initiators is in general from 0.1 to 10% by weight, preferably from 0.5 to 5% by weight, based on the monomers to be polymerized. It is also possible to use a plurality of different initiators in the emulsion polymerization.

Regulators can be used in the polymerization, for example in amounts of from 0 to 0.8 part by weight, based on 100 parts by weight of the monomers to be polymerized, the molar mass being reduced by said regulators. For example, compounds having a thiol group, such as tert-butyl mercaptan, the ethylacrylic esters of thioglycolic acid, mercaptoethynol, mercaptopropyltrimethoxysilane or tert-dodecyl mercaptan, are suitable.

The emulsion polymerization is effected, as a rule, at from 30 to 130° C., preferably from 50 to 90° C. The polymerization medium may consist either only of water or of mixtures of water with liquids miscible therewith, such as methanol. Preferably, only water is used. The emulsion polymerization can be carried out both as a batch process or in the form of a feed process, including the step or gradient procedure. The feed process, in which a part of the polymerization batch is initially taken, heated to the polymerization temperature and partly polymerized and the remainder of the polymerization batch is then fed to the polymerization zone, usually via a plurality of spatially separate feeds, one or more of which comprise the monomers in pure or in emulsified form, continuously, stepwise or with superposition of a concentration gradient, while maintaining the polymerization, is preferred. In the polymerization, a polymer seed can also be initially taken, for example for better adjustment of the particle size.

The manner in which the initiator is added to the polymerization vessel in the course of the free radical aqueous emulsion polymerization is known to the average person skilled in the art. It can either be completely initially taken in the polymerization vessel or used continuously or stepwise at the rate of its consumption in the course of the free radical aqueous emulsion polymerization. Specifically, this depends on the chemical nature of the initiator system and on the polymerization temperature. Preferably, a part is initially taken and the remainder is fed to the polymerization zone at the rate of consumption.

In order to remove the residual monomers, initiator is usually added even after the end of the actual emulsion polymerization, i.e. after a conversion of at least 95% of the monomers.

The individual components can be added to the reactor in the feed process from above, at the side or from below through the reactor bottom.

In the emulsion polymerization, aqueous dispersions of the polymer, as a rule having solids contents of from 15 to 75% by weight, preferably from 40 to 75% by weight, are obtained.

Suitable binders are in particular also mixtures of different binders, for example also mixtures of synthetic and natural polymers.

The paper coating slip according to the invention comprises inorganic pigments as a substantial component. In particular, these are white pigments. For example, titanium dioxide, aluminium oxide, aluminium hydroxide, kaolin, talc, dolomite, clay, bentonite, satin white, calcium carbonate, e.g. in the form of lime, chalk, calcite, marble and/or precipitated calcium carbonate, calcium sulfate and/or barium sulfate, zinc oxide, chalk or coating clay may be mentioned.

Titanium dioxide or calcium carbonate is particularly preferred.

In addition to inorganic pigments, organic pigments, as described, for example, in WO 01/00712 and WO 01/00713, can also be concomitantly used. In the present invention, however, such organic pigments are no longer absolutely essential. The proportion of organic pigments is preferably less than 20 parts by weight, in particular less than 10 parts by weight, particularly preferably less than 5 parts by weight, based on 100 parts by weight of inorganic pigment.

Particularly preferably, no organic pigments are concomitantly used.

According to the invention, the binder and the inorganic pigment are present at least partly in the form of pigment-polymer hybrids. In these hybrids, the organic polymer or binder is chemically or physically bound to the inorganic pigment. In particular, the binder is adsorbed onto the pigment surface.

The pigment-polymer hybrids comprise an independent particle type having a uniform density. On measurement of the density of the pigment-polymer hybrids using an ultracentrifuge by the static density gradient method (at 21° C. and 1 bar), only one density, i.e. one particle type, is determined. The static density gradient method of measurement is described, for example, in W. Mächtle, M. D. Lechner, Progr. Colloid Polym. Sci (2002) 119, 1.

In order to investigate a sample in the static density gradient (stat. DG), a mixture of light solvent and heavy solvent or additive (as a rule metrizamide/H₂O, metrizamide/D₂O) is centrifuged at moderate rotor speeds for at least 22 hours. The different sedimentation and diffusion behavior of heavy and light agent leads to the formation of a concentration gradient and hence a density gradient over the cell. Each radial position of the measuring cell therefore has a different solvent density. The sample or the chemically different components of the sample settle out or float within this density gradient exactly at the radial position at which a mixing ratio of light and heavy agent, corresponding to their particle density, is present. Highly accurate fractionation of samples according to the density and hence the chemical composition is therefore possible.

Since, in the investigated system comprising polymer (about 1 g/cm³), calcium carbonate (from 2.6 to 2.95 g/cm³, depending on modification) and polymer-carbonate hybrid, the densities of the particles differ radically, free polymer can be detected or the absence of free polymer can be demonstrated by means of measurements of the hybrids in suitable static density gradients.

The pigment-polymer hybrids have self-binding properties, as described in FR 04 07 806.

A pigment-polymer hybrid is obtainable, for example, simply by mixing pigment and binder and subsequent drying or preferably by milling of the pigment in the presence of the binder.

In addition to binder and inorganic pigment, the pigment-polymer hybrids may comprise further components, for example dispersants, for example polycarboxylic acid or salts thereof, in particular polyacrylic acid or polyphosphoric acid.

The content of organic polymers and binder in the pigment-polymer hybrids is in particular less than 40 parts by weight, preferably less than 20 parts by weight, particularly preferably less than 15 parts by weight, of organic polymers per 100 parts by weight of the pigments present in the hybrids.

The content of organic polymers and binder in the pigment-polymer hybrids is preferably at least 1 part by weight, particularly preferably at least 3 parts by weight and very particularly preferably at least 5 parts by weight, per 100 parts by weight of the pigments present in the hybrids.

In the paper coating slips according to the invention, organic polymers, in particular binders, and inorganic pigments are particularly preferably used in the form of the pigment-polymer hybrids. In addition to the pigment-polymer hybrids, organic binders and inorganic pigments, which are not present in the form of the pigment-polymer hybrids, may also be used.

Preferably at least 30% by weight, in particular at least 60% by weight and particularly preferably at least 95% by weight and in particular 100% by weight of the inorganic pigments present altogether in the paper coating slip are present in the form of the pigment-polymer hybrids.

Preferably at least 30% by weight, in particular at least 60% by weight and very particularly preferably at least 95% by weight and in particular 100% by weight of the organic polymers or binders present in the paper coating slip are present in the form of the pigment-polymer hybrids.

The paper coating slips may comprise further additives, for example dispersants. Suitable dispersants are polyanions, for example of polyphosphoric acids or of polyacrylic acids (poly salts), which are usually present in amounts of from 0.1 to 3% by weight, based on the amount of pigment.

In addition, the paper coating slips may comprise rheology additives. For example, starch, casein, gelatin, alginates and soybean proteins, hydroxyethylcellulose, methylcellulose and carboxymethylcellulose as modified natural products, and cationically modified starch may be mentioned. However, it is also possible to use conventional synthetic additives, for example those based on vinyl acetate or on acrylate, the latter usually having a content of acid monomers of more than 5, in particular more than 10, % by weight.

The rheology additives may be present, for example, in amounts of from 0.1 to 2% by weight, based on the amount of pigment.

For the preparation of the paper coating slip, the components are mixed in a known manner.

The paper coating slip preferably comprises at least 40% by weight, particularly preferably at least 60% by weight, very particularly preferably at least 80% by weight or 90% by weight of pigment-polymer hybrids, water and other organic solvents having a boiling point of less than 200° C. at 1 bar not being included as a component; in particular it may also comprise at least 95 or 100% by weight of pigment-polymer hybrids.

The paper coating slip according to the invention preferably comprises at least 30 parts by weight, in particular at least 40 parts by weight, of water per 100 parts by weight of inorganic pigment.

The water content of the paper coating slip is usually adjusted to 25 to 75% by weight, particularly preferably 25 to 50% by weight, based on the total paper coating slip (including water).

The paper coating slip can be applied by conventional methods to the papers to be coated (cf. Ullmann's Encyclopädie der Technischen Chemie, 4th edition, Vol. 17, page 603 et seq.).

The papers coated with the paper coating slips according to the invention have a high dry and wet pick resistance (adhesion of the paper coating slip). They are therefore particularly suitable for offset printing in which, owing to the high viscosity of the printing ink, the coated paper is subjected to high tensile forces.

The papers coated with the paper coating slips according to the invention exhibit good printability. The papers are also suitable in particular for offset printing processes.

### EXAMPLES

### A) Preparation of Pigment-Polymer Hybrids

The preparation carried out in accordance with the process described in FR 04 07 806 from Omya.

For the preparation of the hybrid 1, calcium carbonate slurries (Hydrocarb 2 GU from Omya AG) were milled in a Dispermat SN-C 12 mill in the presence of an aqueous dispersion of a carboxylated styrene/butadiene copolymer (Styronal® D536 from BASF AG) as a binder.

The milling conditions were:

| | |
|---|---|
| Speed of the mill | 5500 rpm |
| Duration of milling | 30 min |
| Slurry concentration | 66% |
| Ball size | 33 mm diameter |
| Ball material | Glass |

For hybrid H1, 10 parts of binder (solid) and 0.3 part of Polysalz® S (dispersant) were used per 100 parts of CaCO₃, and 0.4 part of Polysalz S was added after the milling.

### B) Detection of the Physical and/or Chemical Binding of the Polymer to the Pigment

Polymer hybrid H1 and the polymer Styronal® D536 used were measured in the statistic density gradient of the ultracentrifuge by the method described above. By using four different density gradients, a density range from 0.95 g/cm³ to 1.30 g/cm³ was covered.

In the measurement of the polymer used, a sharp peak was observed at a density of 0.99 g/cm³.

In the measurement of polymer hybrid H1, no peaks are observed in the entire accessible density range, in particular at the density of the pure polymer. The polymer/pigment hybrid therefore comprises no unbound polymer.

### C) Preparation of the Paper Coating Slips

The paper coating slips were prepared by stirring the components according to the following table:

TABLE 1
Formulations

Formulation

| | 1 | 2 |
|---|---|---|
| CaCO₃ | | 100 |
| Pigment hybrid | 100 | |
| Styronal D 536 | | 10 |
| Polysalz S * | | 0.3 |
| Sterocoll FD ** | 0.13 | 0.13 |
| Solids content | 65.7 | 65.3 |
| Viscosity (CPS) 100 rpm | 515 | 670 |
| pH | 8.5 | 8.5 |
| Water retention | 121 | 127 |

* Polyacrylic acid salt
** Polyacrylate-based rheology additive

### D) Testing of Performance Characteristics

The base paper used was a wood-free coating paper having a basis weight of 70 g/m². The paper coating slip was applied on one side with 10 g/m² on a laboratory coating machine. The drying was effected using an IR lamp. Before the testing of the performance characteristics, the paper passed four times through a laboratory calender (1 pair of rolls, nip pressure: 2000 N/cm).

Dry pick resistance (IGT dry)

Strips measuring 33×3 cm were cut in the longitudinal direction from the papers to be tested, and these strips were stored for 15 hours at 27° C. with a relative humidity of 50% in a conditioning chamber.

The strips were then printed in a printing unit (IGT printability tester AC2/AIC2) using a standard ink (printing ink 3808 from Lorilleux-Lefranc).

The test strips are passed through the printing unit at a continuously increasing speed (maximum speed 200 cm/sec). The speed in cm/sec at which 10 picks from the paper coating slip (pick points) have occurred after the beginning of printing is stated as a measure of the dry pick resistance.

Offset Test

Paper:

Samples measuring 240×46 mm are cut in the longitudinal direction from the papers to be tested.

Carrying Out the Test:

A corresponding amount of the printing ink is added to the inking cylinder and allowed to run for 1 min. A printing disk is then inserted and is inked for 30 s.

The printing speed is 1 m/s. A paper strip is brought back to the starting position on a print sample support with the printed paper strip. After a specified time span, the printing process is started again without changing the printing disk. This process is repeated several times.

After each pass, the picking on the printed side of the paper strip is assessed visually. The number of passes until picking occurs for the first time is stated. In the case of very pronounced picking, the last pass is stated only as a half (for example, pronounced picking after the 3rd pass is stated as 2.5).

Statement of the Result:

Number of printing processes until the occurrence of the initial picking.

The results are summarized in table 2 shown below.

TABLE 2

Example

| | 1 | 2 |
|---|---|---|
| IGT dry (cm/s) | 115 | 100 |
| PB offset | 5 | 3 |

The results show that substantially increased binding powers are obtained in the case of the pigment hybrid in comparison with example 2, with otherwise good paper properties.

1. An aqueous paper coating slip comprising organic polymers as binders and inorganic pigments, wherein the binders are present at least partly in the form of a pigment-polymer hybrid in which the binder is chemically or physically bound to the inorganic pigments.

2. The aqueous paper coating slip according to claim 1, wherein the binder is a polymer which is composed of at least 40% by weight of main monomers selected from C₁- to C₂₀-alkyl(meth)acrylates, vinyl esters of carboxylic acids comprising up to 20 carbon atoms, vinyl aromatics having up to 20 carbon atoms, ethylenically unsaturated nitrites, vinyl halides, vinyl ethers of alcohols comprising 1 to 10 carbon atoms, aliphatic hydrocarbons having 2 to 8 carbon atoms and one or two double bonds or mixtures of these monomers.

3. The aqueous paper coating slip according to claim 1, wherein the binder is composed of at least 60% by weight of butadiene or mixtures of butadiene and styrene.

4. The aqueous paper coating slip according to claim 1, wherein the binder is composed of at least 60% by weight of C₁- to C₂₀-alkyl (meth)acrylates or mixtures of C₁- to C₂₀-alkyl(meth)acrylates with styrene.

5. The aqueous paper coating slip according to claim 1, wherein the binder is an emulsion polymer.

6. The aqueous paper coating slip according to claim 1, wherein the inorganic pigments are white pigments.

7. The aqueous paper coating slip according to claim 1, wherein the binder content is from 5 to 30 parts by weight per 100 parts by weight of inorganic pigments.

8. The aqueous paper coating slip according to claim 1, wherein the water content is at least 30 parts by weight per 100 parts by weight of inorganic pigments.

9. The aqueous paper coating slip according to claim 1, wherein at least 50% by weight of the binders are present in the form of the pigment-polymer hybrid.

10. The aqueous paper coating slip according to claim 1, wherein the pigment-polymer hybrid is produced by a process comprising preparing a mixture of the inorganic pigment, the binder and optional additives, and removing any concomitantly used water or solvent down to a residual content of less than 20 parts by weight per 100 parts by weight of inorganic pigment.

11. The aqueous paper coating slip according to claim 1, wherein the pigment-polymer hybrid is produced by a process comprising preparing a mixture of the inorganic pigment, the binder and optional additives, and milling the inorganic pigment in the presence of the binder.

12. A process of coating paper or cardboard, wherein said process comprises applying to paper or cardboard the aqueous paper coating slip according to claim 1.

13. A coated paper or cardboard comprising paper or cardboard coated with the paper coating slip according to claim 1.

14. The aqueous paper coating slip according to claim 6, wherein the white pigments are selected from the group consisting of titanium dioxide and calcium carbonate.

15. A method of preparing the pigment-polymer hybrid according to claim 1, wherein said method comprises preparing a mixture comprising the inorganic pigment, the binder and optional additives, and removing any concomitantly used water or solvent down to a residual content of less than 20 parts by weight per 100 parts by weight of inorganic pigment.

16. A method of preparing the pigment-polymer hybrid according to claim 1, wherein said method comprises preparing a mixture comprising the inorganic pigment, the binder and optional additives, and milling the inorganic pigment in the presence of the binder.
